(19) United States
(12) Patent Application Publication
(10) Pub. No.: US 2022/0369618 A1
(43) Pub. Date: Nov. 24, 2022

(54) APPARATUS AND SYSTEM FOR TESTING RODENTS' COGNITIVE ABILITY

(71) Applicants: Université d'Aix Marseille (AMU), Marseille (FR); Centre National de la Recherche Scientifique, Paris (FR)

(72) Inventors: François Silvio Paul Hubert Roman, Forcalquier (FR); Guy Pierre Roger Escoffier, Marseille (FR)

(73) Assignees: Université d'Aix Marseille (AMU), Marseille (FR); Centre National de la Recherche Scientifique, Paris (FR)

(21) Appl. No.: 17/755,200

(22) PCT Filed: Oct. 22, 2020
(86) PCT No.: PCT/EP2020/079758

§ 371 Date: Apr. 22, 2022

(30) Foreign Application Priority Data
Oct. 22, 2019 (EP) 19306368.2

(51) Int. Cl. A01M 23/38; A01M 23/12

(52) U.S. Cl. CPC A01M 23/38; A01M 23/12; A01M 31/002

(57) ABSTRACT

The disclosure relates to an apparatus and a system for testing the cognitive ability of a rodent, comprising a testing chamber, a retarding zone connected to the entrance chamber and including at least one obstacle configured to slow down the rodent's movement to the entrance chamber, and an optional transfer chamber connected to the entrance chamber via the retarding zone for transfer of the rodent to and from an area external to the apparatus. The testing chamber comprises an entrance chamber, a plurality of corridors each connected to the entrance chamber via a corridor's first end portion, and at least one odor diffuser for diffusing odors in the plurality of corridors.

### FIELD OF THE DISCLOSURE

The present disclosure concerns, but is not limited to, an apparatus for testing a rodent's cognitive ability, such as the memory and/or other brain functions, as well as a system comprising a plurality of such apparatuses. The present disclosure further concerns a method for testing the cognitive ability of a rodent, and a method for assessing the efficacy of a drug on a rodent.

### TECHNICAL BACKGROUND

Human memory impairment is a distinct cognitive trouble. However, memory is not a monolithic system, but is rather composed of multiple systems which operate in parallel to support behavior. An animal model of human memory impairment was first developed in monkeys and allowed to identify the anatomical components of the memory supporting the declarative memory. Then, with the development of transgenic and gene-targeting techniques, new knowledge about learning and memory processes could be obtained from studies on genetically modified mice. The question of making sure that mice model can reproduce human memory impairment yet remained open.

One approach to test animals' memory consists in taking advantage of mice's acute sense of smell, by using rewarded associations with olfactory cues. Mice are indeed macrosmatic animals which rely on the sense of olfaction to detect food sources, recognize social and mating partners, and avoid predators. Many brain functions of mice, including learning and memory, social interaction, fear, and anxiety, are closely associated with mice's sense of olfaction, and behavior tasks designed to evaluate these brain functions may use odors as cues.

In this line, with the aim of probing mices' memory and higher cognitive processes, an apparatus named the Olfactory Tubing Maze (OTM) was developed. This apparatus is for example described in the following articles: Roman et al., “The Olfactory Tubing Maze: A New Apparatus for Studying Learning and Memory Processes in Mice”, Journal of Neuroscience Methods (2002), 117, pp. 173-181 »; Girard et al., “Onset of Hippocampus-Dependent Memory Impairments in 5×FAD Transgenic Mouse Model of Alzheimer's Disease”, Hippocampus (2014), 24, pp. 762-772; Girard et al., “Chronic Treatments with a 5-HT4 Receptor Agonist Decrease Amyloid Pathology in the Entorhinal Cortex and Learning and Memory Deficits in the 5×FAD Mouse Model of Alzheimer's Disease”, Neuropharmacology (2017), 126, pp. 128-141.

The OTM is depicted in FIGS. 1A and 1s composed of four identical testing chambers 1 connected to each other by semicircular tubes having elbow portions 2 and straight portions 3. Each testing chamber 1 comprises two straight tubes 4 connected to a central cube 5. On top of each cube 5, an inverted fan 6 exhausts neutral or scented air, which is ejected from ends 7 of the tubes 4. One of such tube end 7 is further depicted in an enlarged view in FIG. 1B, and is provided with a water port 8 arranged in a well, with a port 9 through which either odors or neutral air may enter, and with a buzzer (not shown) as a source of reprimand. Entry to and exit from the testing chambers 1 is permitted by opening automated doors 10 arranged on two opposite sides of each cube 5. The automated doors 10 successively automatically open and close and impose to the mouse a predetermined moving direction into the maze. The movement of the mouse is detected by photoelectric cells 11.

Despite the knowledge brought about by the OTM, which allows to selectively identify distinct subcategories of long-term memory for mice, such apparatus merely represents a preliminary approach towards a full understanding of mice's cognitive processes, and shows severe technical defects. In particular, the OTM does not take into account all the specific characteristics of mice, such as mices' hyperactive behavior. Indeed, mice tend to favor the shortest way, and need to be softly inhibited in their movements. Yet, within the OTM, the mouse has to wait in front of a closed door of each testing chamber, which creates a hard, unprogressive inhibition of its movement.

Further, in the OTM, a mouse standing in front of the door 10, once the door opens, is only given the choice between, at most, two olfactory associations in the testing chamber 1. Accordingly, the reward chance for the mouse, when only one reward is present in the testing chamber, is already at a high chance level, i.e., 50%. Such reward chance level leaves a narrow margin for improvement, and allows a usual improvement of about 30%.

Furthermore, the presence of buzzers as a source of reprimand for the mouse is not adapted to all types of mice or, more generally, to all rodents, and could negatively affect the course of other experiments carried out in parallel by introducing a bias.

Hence, there still exists a need for apparatus for testing rodents' cognitive ability that allow to test the different sub-categories of long-term memory in a more subtle and sensitive manner.

### SUMMARY OF THE DISCLOSURE

In what follows, the term “comprise” is synonym of (means the same as) “include” and “contains”, is inclusive and open and does not exclude other non-recited elements. Moreover, in the present disclosure, the terms “about” and “substantially” are synonyms of (mean the same as) a margin less and/or more than to 20%, for example 10%, of the respective value.

In the present disclosure, by “olfactory cue association” or “olfactory association”, it is meant an association between an odor and a reward, a reprimand, or nothing (i.e., neither a reward nor a reprimand). A reward may for example be a source of positive reinforcement, such as hydric reinforcement, e.g. in the form of a drop of water. A reprimand may for example be a source of negative reinforcement, such as a light signal, e.g. in the form of a non-aversive light signal.

One of the objectives of the present disclosure is to provide an apparatus, for example in form of a module configured to be connected to one or more further modules, for example identical to the module, for testing a rodent's cognitive ability, that allows to test different brain functions and, particularly but not exclusively, the memory as well as the different sub-categories of long-term memory, in an appropriate and sensitive manner.

According to a first aspect of the present disclosure, such an objective is attained by an apparatus for testing the cognitive ability of a rodent, comprising a testing chamber comprising: an entrance chamber, a plurality of corridors each connected to the entrance chamber via a corridor's first end portion, and at least one odor diffuser for diffusing odors in the corridors. The plurality of corridors may have substantially identical shape and/or dimensions. The at least one odor diffuser may be arranged in at least one of the plurality of corridors, such as, for example, in a second end portion of the at least one of the plurality of corridors. The testing chamber may further comprise at least one source of reinforcement. The at least one source of reinforcement may be arranged in the at least one of the plurality of corridors. The apparatus further comprises a retarding zone connected to the entrance chamber and comprising at least one obstacle configured to slow down the rodent's movement to the entrance chamber. The apparatus may further comprise an optional transfer chamber connected to the entrance chamber via the retarding zone for transfer of the rodent to an area external to the apparatus. The area external to the apparatus may be an area outside the testing chamber, such as for example a rest area, or one or more further apparatuses. The one or more further apparatuses may be identical to the apparatus or not.

According to a second aspect of the present disclosure, the above-mentioned objective is attained by a system for testing the cognitive ability of a rodent comprising a plurality of apparatuses, for example in the form of modules, as defined above and connected to each other by the transfer chamber. According to one or more embodiments, the apparatus does not comprise the transfer chamber. In these embodiments, the transfer chamber may be part of the system. Be the transfer chamber a part of an apparatus or a part of the system, such a system offers the possibility of performing automated tests in an easy manner, as compared to a configuration of a system comprising only one testing chamber.

The apparatus and system of the present disclosure may be configured to use olfactory cues to test the cognitive ability of a rodent. Testing the cognitive ability of a rodent may for example comprise probing a rodent's memory and/or probing other brain functions of a rodent. According to one or more embodiments, the at least one odor diffuser, which may comprise any means capable of producing, diffusing or releasing an odoriferous substance, may permit to associate olfactory cues to rewards and/or reprimands and/or nothing. The apparatus and system of the present disclosure are thus particularly adapted to rodents whose behaviors strongly rely on their sense of olfaction. The apparatus and system of the present disclosure may provide an experimental frame for rodents' behavioral tests designed to evaluate brain functions, such as memory abilities, olfactory abilities, visual abilities, spatial abilities, or any other function performed by the brain.

According to one or more embodiments, the apparatus and system are adapted to test the memory and/or other brain functions of a rodent selected from the group comprising a mouse, a rat, a squirrel, a prairie dog, a chipmunk, a chinchilla, a porcupine, a beaver, a guinea pig, a hamster, a gerbils, a capybara. According to one or more embodiments, the apparatus and system are adapted to test the memory and/or other brain functions of mice. The behavioral tests to which a rodent may be subjected in the apparatus and system according to the present disclosure may depend on the animal species used, or on a selected strain of the animal species used. For example, tests intended for rats and mice may be different, as the mouse is more exploratory and more mobile than the rat. The development of behavioral tests may be easily adapted to the rodent species under consideration, thus allowing the measurement of different behavioral responses, including complex behavioral responses.

According to one or more embodiments, the plurality of corridors comprised in the at least one testing chamber comprises three or more corridors. In a corresponding manner, the entrance chamber may be provided with three or more openings for connection with the corridors. Increasing the number of corridors may for example allow to increase the number of potential olfactory cue-reward/reprimand/nothing associations in the system. The inventors have demonstrated that increasing the number of corridors connected to the testing chamber improves the sensitivity of the olfactory tests to which rodents may be subjected. Hence, due to the increased test sensitivity stemming from an embodiment of the apparatus comprising at least three corridors, as compared to prior art apparatuses, the apparatus is particularly adapted to be in better agreement with the principle of the 3Rs (Replacement, Reduction and Refinement). Such principle provides a framework for performing more human animal research and has been followed in national and international legislation and regulations on the use of animals in scientific procedures, as well as in the policies of organizations that fund or conduct animal research. According to one or more embodiments, the plurality of corridors comprises four or five corridors. According to one or more embodiments, the plurality of corridors comprises four corridors.

The apparatus of the present disclosure comprises at least one obstacle configured to slow down the rodent's movement to the entrance chamber. The at least one obstacle does not prevent or impede the passage of the rodent, but only causes an impairment interfering with a free movement of the rodent. In other words, the obstacle has the function of a retarder for the rodent. Slowing down the rodent in its movement offers time to the rodent to reflect on potential olfactory cue associations. The inventors have found that the presence of such an obstacle is adapted to test the memory and/or other brain functions, for example, of a rodent showing hyperactive behavior. For example, the apparatus of the present disclosure is adapted to test the memory of mice, which are animals generally exhibiting hyperactive behavior.

The at least one obstacle configured to slow down the rodent's movement may take different forms, the only condition being that the at least one obstacle is configured to cause an impairment interfering with a free movement of the rodent in the retarding zone. The at least one obstacle may slow down the rodent's movement in different ways that may for example be adapted to specific behaviors of the rodent. According to one or more embodiments, the at least one obstacle may induce a soft inhibition to the rodent. For example, the at least one obstacle may impair the rodent's movement in a soft, progressive manner. As an example of soft inhibition, the at least one obstacle configured to slow down the rodent's movement may comprise a plurality of passageways for a rodent. According to one or more embodiments, the plurality of passageways may be substantially identical. Rodents generally showing hyperactive behavior, such as mice, will tend to favor the shortest way, if available and recognizable, and may need to be softly inhibited in their movements. Indeed, for some rodents, a hard inhibition, as opposed to a soft inhibition, may affect the sensitivity of the tests to which the rodent is subjected in a negative way, by giving a source of distraction to the rodent, thereby introducing a bias. A hard inhibition may for example be induced from system features that abruptly stop the rodent in its freedom of movement. According to one or more embodiments, the at least one obstacle comprises a floor, for example arranged at a predetermined height from the ground, in which one or more holes are defined. Embodiments of an apparatus comprising such a floor provided with one or more holes not only cause a soft inhibition, but may also limit the number of doors present in the apparatus, thus reducing the risk of injuries or even death of a rodent during a test due to possible malfunctioning of the opening and closing of a door.

According to one or more embodiments, the retarding zone comprises a retarding chamber housing the at least one obstacle. According to one or more embodiments, the floor provided with one or more holes may be adjustably fixed at an intermediate height of the retarding zone, for example at about middle height of the retarding zone, also when the retarding zone comprises a retarding chamber. According to one or more embodiments, the holes are symmetrically arranged with respect to a center of the floor. According to one or more embodiments, the holes may be staggered with respect to the corridors of the testing chamber to which the retarding zone is connected. Such staggering may inhibit the rodent's hyperactive behavior in a still softer manner. According to one or more embodiments, the floor is provided with circular holes, for example in number of four, for example symmetrically arranged with respect to the center of the floor. Each hole may have an exemplary diameter of between 3 and 7 cm.

According to one or more embodiments, the at least one obstacle comprises a platform adapted to have the rodent's head at the level of the entrance chamber. For example, the platform may be disposed at an intermediate height of the retarding chamber.

According to one or more embodiments, the apparatus comprises a single testing chamber. According to one or more embodiments, the apparatus comprises at least two testing chambers.

According to the present disclosure, a transfer chamber may be connected to the entrance chamber via the retarding zone, which may for example comprise a retarding chamber. As used in the description and in the claims, a “transfer chamber” is a part either of the apparatus or of the system and is configured to allow the movement of the rodent between the at least one testing chamber of the apparatus and a place other than the testing chamber, for example for transfer of a rodent to and from an area external to the testing chamber or to one or more further apparatuses. For example, according to one or more embodiments, the transfer chamber may allow to guide the movement of the rodent toward and from, a rest area. According to one or more embodiments, the transfer chamber may allow to guide the movement of the rodent from the testing chamber to one or more further apparatuses and vice versa. The rest area and the further apparatuses may be part of the system.

According to one or more embodiments, the retarding zone may be partly or completely arranged in the transfer chamber. According to one or more embodiments, the retarding zone may be arranged outside the transfer chamber, for example, as mentioned above, in a retarding chamber, separate from the transfer chamber. According to one or more embodiments, the retarding chamber may be formed into a single piece with the transfer chamber.

According to one or more embodiments, the apparatus may comprise at least two testing chambers. According to one or more embodiments, the apparatus may comprise at least two retarding zones or chambers, each connecting a respective entrance chamber of the testing chambers to the transfer chamber. Such a configuration offers the possibility of performing automated tests in the apparatus in an easy manner, as compared to a configuration of the apparatus comprising only one testing chamber.

According to one or more embodiments of an apparatus comprising at least two testing chambers, the transfer chamber may comprise a transfer tube having end portions each connected, respectively, to a respective retarding zone or chamber. According to one or more embodiments, the transfer tube comprises at least one door in an intermediate portion thereof. For example, the at least one door may be an automatic lift door, that may be controlled, for example, via a control unit comprising a computer. The control unit may be configured to set the door closed or open when the rodent is detected in a specific location of the system, for example by means of presence sensors arranged in the retarding chamber and/or the corridors. For example, the door may be set to be closed when the rodent is detected in the retarding chamber, and/or may be set to be open when the rodent is detected in a second end portion of a corridor.

According to one or more embodiments, the corridors have substantially the same shape and differ, at the most, in length and/or width. According to one or more embodiments, differ, at the most, by 20%, 10%, 5%, 2% or 1% in length and/or by 20%, 10%, 5%, 2% or 1% in width. According to one or more embodiments, the corridors are of substantially identical shape and dimensions. In this manner, the end portions of the corridors may be substantially equidistant from the entrance chamber. Having substantially identical shape and dimensions for the corridors substantially respects equiprobability. By “respecting equiprobability”, it is meant influencing as less as possible the choice of the rodent to choose one corridor instead of another. When the rodent's choice of a particular corridor only depends on an olfactory cue association, it is possible to test the rodent's specific memory subcategories and/or other brain functions with improved selectivity. Such an olfactory cue association may have been learnt by the rodent beforehand, for example in a learning process prior to or during a test. Hence, if a corridor is for example too much shorter than another one within a testing chamber, the rodent might remember this difference, which may amount to a bias unduly influencing a test. Indeed, after a certain time, a rodent subjected to a test in an apparatus, e.g. a maze, may learn and remember the apparatus' spatial configuration. Within an apparatus respecting at least substantial equiprobability or full equiprobability, the rodent may substantially or totally lose its spatial bearings, respectively, thereby improving a test capability to test the rodent's specific memory subcategories and/or other brain functions.

According to one or more embodiments, the plurality of corridors connected to the entrance chamber may lie on the same plane, which may be, for example, parallel to the ground. However, according to alternative embodiments, the plurality of corridors connected to the entrance chamber may lie on distinct planes. In both cases, according to one or more embodiments, two consecutive corridors of a testing chamber define an angle therebetween, which may for example be substantially the same for each couple of consecutive corridors. A substantially equal angle between all consecutive corridors of a testing chamber may contribute to provide equiprobability.

According to one or more embodiments, the plurality of corridors radially extend from a centrally arranged entrance chamber and are angularly equally spaced apart from each other.

According to one or more embodiments, the plurality of corridors are of tubular shape and have, for example, a substantially circular, rectangular or square cross-section. According to one or more embodiments, the plurality of corridors are straight tubes. According to one or more embodiments, the dimensions of each of the plurality of corridors are between 3 and 7 cm in diameter. These dimensions are adapted to the size of a mouse.

According to one or more embodiments, the dimensions of the plurality of corridors are between 20 and 26 cm in length. The inventors have observed that such length is adapted to certain tests for testing the memory and/or other brain functions of a rodent. Indeed, the inventors observed that if the corridors are too short, a rodent may not have enough time to reflect on odors coming from the corridors prior to entering the corridors, while, if the corridors are too long, a rodent may be too strongly inhibited from exploring the corridor.

When the apparatus comprises at least two testing chambers, according to one or more embodiments, the at least two testing chambers may be of substantially identical shape and dimensions, which contributes to provide equiprobability. When the testing chambers are of substantially identical shape and dimensions, the rodent may lose its spatial bearings from one testing chamber to another. In such a manner, any knowledge acquired by the rodent throughout a learning process prior to or during a test may let the rodent focus on the odors diffused in the corridors and their signification, i.e., what they are associated with (e.g., a reprimand, a reward, nothing . . . ), without interference with other cues than odor cues to be explored by the rodent in view of, for example, getting a reward or avoiding a reprimand.

When the apparatus comprises at least two testing chambers, the apparatus may also comprise at least two retarding chambers. When the apparatus comprises at least two retarding chambers, according to one or more embodiments, the at least two retarding chambers may be of substantially identical shape and dimensions, which contributes to provide equiprobability. Indeed, in this manner, a rodent under consideration during a test may completely lose its spatial bearings.

The at least one odor diffuser may be arranged in at least one of the plurality of corridors. According to one or more embodiments, the at least one odor diffuser is arranged in at least one second end portion of one or more of the corridors, or in all corridors. According to one or more embodiments, each corridor of the plurality of corridors comprises an odor diffuser. Thus, according to one or more embodiments, the testing chamber comprises a plurality of odor diffusers respectively arranged in the plurality of corridors. According to one or more embodiments, each corridor of the plurality of corridors comprises an odor diffuser and a source of reinforcement. According to one or more embodiments, each odor diffuser is arranged in a second end portion of a respective corridor. The at least one odor diffuser may comprise an air port defined in a wall of one or more of the corridors. The at least one odor diffuser may further comprise one or more pipes connected to the air port for carrying as many odors from respective one or more odor sources or reservoirs.

According to one or more embodiments, at least one entrance chamber may comprise an opening and, optionally, a fan or a pump fluidly connected thereto. Thanks to the fan or the pump, odors diffused in the corridors may be better directed from the corridors to the entrance chamber of the testing chamber. In this manner, a rodent may better smell odors in and/or at the proximity of the entrance chamber and, thus, be attracted to enter the entrance chamber and/or the corridors. For example, the fan may be an inverted fan. According to one or more embodiments, the opening of the at least one entrance chamber may be further fluidly connected to a pipe intended to carry neutral air, which may be used to chase the odors away from the testing chamber, in between two trials of a test for example, when the at least one odor diffuser is turned off.

According to one or more embodiments, the testing chamber comprises a plurality of sources of reinforcement respectively arranged in the plurality of corridors. According to one or more embodiments, each source of reinforcement is arranged in a second end portion of a respective corridor.

According to one or more embodiments, the at least one source of reinforcement comprises at least one of a source of positive reinforcement and/or a source of negative reinforcement. Sources of positive or negative reinforcement may be arranged in the testing chamber, for example in the second end portion of the corridors.

According to one or more embodiments, the source of negative reinforcement comprises a means for delivering a reprimand.

According to one or more embodiments, the means for delivering a reprimand may comprise a means for emitting non-aversive light signals, or a means for emitting sounds, e.g., a buzzer, or combinations thereof. According to one or more embodiments, the source of negative reinforcement comprises a means for emitting a non-aversive light signal, thus amounting to a soft reprimand for the rodent. The use of such a soft reprimand for the rodent may be preferred over harder reprimands, such as in prior art systems comprising sound devices, e.g., buzzer, which may create more trauma for the rodent. Moreover, such a non-aversive light signal, as compared to a buzzer for example, may allow to use two or more systems according to the present disclosure proximate to each other (e.g., in the same room), without disturbing the course of experiments performed in parallel in said system by introducing a bias.

According to one or more embodiments, the source of positive reinforcement may comprise a means for delivering a reward. According to one or more embodiments, the means for delivering a reward may comprise a water port and/or a food port or a container for containing water and/or food. The water port provided in one or more corridors may be used to introduce therein water, for example in the form of a water drop, which may be perceived as a reward leading to a hydric reinforcement of the rodent. Such a reward is both universal and easy to be dispensed. For example, a water port may be arranged within the second end portion of the corridors.

According to one or more embodiments, the apparatus of the present disclosure comprises at least one presence sensor for detecting the presence of a rodent in the entrance chamber and/or in one or more of the plurality of corridors or in all corridors. According to one or more embodiments, the presence of a rodent may be detected without the need of presence sensors, e.g., visually, in the entrance chamber and/or in one or more of the plurality of corridors. According to one or more embodiments, the apparatus comprises at least one presence sensor for detecting the presence of a rodent in at least one corridor, whereas the presence of a rodent may be detected without the need of presence sensors, e.g., visually, in the remaining corridor(s). The at least one presence sensor may for example comprise two photovoltaic cells, arranged on opposite side of the wall of the corridor(s). For example, one cell may emit an infrared beam that the other cell receives. In this manner, when the rodent interrupts the beam between two cells, the rodent may be detected. According to one or more embodiments, the apparatus comprises at least one presence sensor arranged in a second end portion of the corridor(s). According to one or more embodiments, a further presence sensor may be provided, for example, in the retarding chamber, in order, for example, to automatically close the at least one door comprised in the transfer tube when detecting a rodent in said retarding chamber.

According to one or more embodiments, the apparatus or the system further comprises a control unit including a computer. Thanks to the control unit, tests performed in the apparatus or system may be fully automated. The control unit may for example be configured to process the information sent from the at least one presence sensor in real time in order to trigger the delivery of a reward or a reprimand in a source of positive, or, respectively, negative reinforcement. The control unit may be further configured to control the opening/closure of all doors provided in the system, e.g., based on the detection of the rodent in a specific location of the system. The control unit may be further configured to control the turning on/off of inverted fans, or odor diffusers, e.g., through the command of electronic valves comprised in the air port, according to a predetermined program, and based on the detection of the rodent in a specific location of the system. The control unit may also be configured to record the results of each trial of a test, e.g., by recording the number of successful trials (e.g., the number of times the rodent finds a reward) and missed trials (e.g., the number of times the rodent finds a reprimand). The control unit may also be configured to associate odors with rewards, reprimands, or nothing (neither rewards nor reprimands). Such association may be predetermined or random. Alternatively or additionally, the control unit may be configured to execute a program of attribution of odors to the plurality of corridors during a test, e.g., a series of trials. According to one or more embodiments, the program of attribution of odors may correspond to a predetermined random variation of the attribution of odors to the plurality of corridors throughout a test. In other words, one odor may not be permanently attributed to one same corridor during a test. For example, an odor of rose may be diffused in a first corridor during a first trial of a test, and may be diffused in a second corridor during a second trial, while, during the second trial, an odor of jasmine will be diffused in the first corridor. The randomness of the program of attribution of odors to the plurality of corridors may contribute to provide equiprobability.

According to a third aspect, the present disclosure concerns a method for testing the cognitive ability of a rodent, for example the long-term memory of a rodent or other cognitive abilities of a rodent, such as the olfactory ability, the method comprising:
introducing a rodent in the apparatus according to the first aspect or the system according to the second aspect;
diffusing at least one odor in at least one of the plurality of corridors via the at least one odor diffuser;
associating the at least one odor with a reward or a reprimand in at least one of the plurality of corridors;
triggering the release of the reward or the reprimand when the rodent reaches the second end portion of the at least one of the plurality of corridors where the at least one odor is associated with a reward or, respectively, a reprimand; and
assessing a performance of the rodent, wherein the assessing comprises counting the number of times the rodent is successful in getting rewards and/or avoiding reprimands.

The introduction of the rodent in the apparatus according to the first aspect or the system according to the second aspect may be carried out prior to or after the step of diffusing at least one odor and/or the step of associating the at least one odor with a reward or a reprimand. According to one or more embodiments of the method according to the third aspect, the method further comprises the association of at least one odor with nothing, i.e., neither a reward nor a reprimand. The association of odors with rewards, reprimands, or nothing (neither rewards nor reprimands) may be predetermined or random. Alternatively or additionally, the attribution of odors to the plurality of corridors during a test or series of trials, may consist in a random variation of the attribution of odors to the plurality of corridors throughout the test. In other words, one odor may not be permanently attributed to one same corridor during a test. For example, an odor of rose may be diffused in a first corridor during a first trial of a test, and may be diffused in a second corridor during a second trial, while, during the second trial, an odor of jasmine will be diffused in the first corridor. The randomness in the variation of the attribution of odors to the plurality of corridors during a test, which may be predetermined and carried out via a predetermined program, may contribute to provide equiprobability.

According to a fourth aspect, the present disclosure concerns a method for assessing the efficacy of a drug on a rodent, comprising:
applying the method according the third aspect to the testing of a first rodent;
applying the method according the third aspect to the testing of a second rodent;
administering a drug to the second rodent prior to applying said method to the testing of the second rodent;
comparing the performance of the first rodent with the performance of the second rodent;
assessing the efficacy of the drug based on the comparison between the performance of the first rodent and the performance of the second rodent.

The performance of the second rodent, i.e., the rodent to which a drug is administered, may for example be deemed to be superior to the performance of the first rodent. A superior performance of the second rodent may for example amount to a superior number of times the second rodent is successful in getting rewards and/or avoiding reprimands, as compared to the number of times the first rodent is successful in getting rewards and/or avoiding reprimands.

Comparing the performance of the first rodent with the performance of the second rodent may comprise the step of validating the fact that the performance of one rodent is superior to the performance of another rodent.

In certain examples, validating a superior performance of, for example, the second rodent over the first rodent, may consist in repeating the method according to the fourth aspect a predetermined amount of times, for example at least six times. According to one or more embodiments, each repetition may involve a different first rodent and a different second rodent, each selected from a group of first rodents, and respectively, in a group of second rodents, each group comprising, for example, at least six rodents. Validating a superior performance of, for example, the second rodent over the first rodent, may thus imply validating the superior performance of the second rodent over the first rodent, each time the method is repeated, e.g., at least six times.

Assessing the efficacy of the drug may consist in validating the efficacy of the drug, which may be done, for example, once validated the fact that the performance of the second rodent, to which the drug is administered, is superior to the performance of the first rodent.

When the first rodent and the second rodent are substantially identical, for example, when the first rodent are the same age and are from the same strain, and when the first rodent is not administered any drug, the method of the fourth aspect may thus comprise a control experiment.

According to one or more embodiments, the method according to the fourth aspect further comprises administering a drug to the first rodent prior to applying the method according the third aspect to the testing of the first rodent. The drug administered to the first rodent may be the same as the drug administered to the second rodent. The second rodent may be different from the first rodent, in the sense that the first and second rodents show a difference, e.g., their strain, their age, a different stage of a disease . . . etc. Such a difference between the first rodent and the second rodent may be responsible for a different response of the rodent to a drug. In these cases the method according to the fourth aspect may thus be efficient for assessing the efficacy of a same drug on two rodents presenting a difference.

According to one or more embodiments, the first rodent and the second rodent are from the same strain.

The embodiments described above are not exhaustive. In particular, it is understood that additional embodiments can be considered on the basis of different combinations of the explicitly described embodiments. Unless otherwise specified in the present disclosure, it will be apparent to the skilled person that all the embodiments described above can be combined together. For example, unless otherwise specified, all features of the embodiments described above, whichever embodiment of the apparatus they refer to, can be combined with or replaced by other features from other embodiments.

### BRIEF DESCRIPTION OF THE DRAWINGS

The present disclosure will be better understood and other advantages and embodiments will become clear on reading the description that follows, given purely by way of indication and in no way limiting, and by referring to the appended figures, in which:

FIG. 1A is a schematizing representation of an Olfactory Tubing Maze (OTM) according to the prior art.

FIG. 1B is a schematizing representation of one tube extremity of the OTM of FIG. 1A.

FIG. 2A is a schematizing representation showing a perspective top view of an example of system for testing the cognitive ability of a rodent according to one or more embodiments of the present disclosure.

FIG. 2B is an enlarged view of a part of the system shown in FIG. 2A.

FIG. 2C is an enlarged view of a second end portion of a corridor comprised in the system shown in FIG. 2A.

FIG. 3 is a schematizing representation of a rodent trying to find its way in the system shown in FIG. 2A.

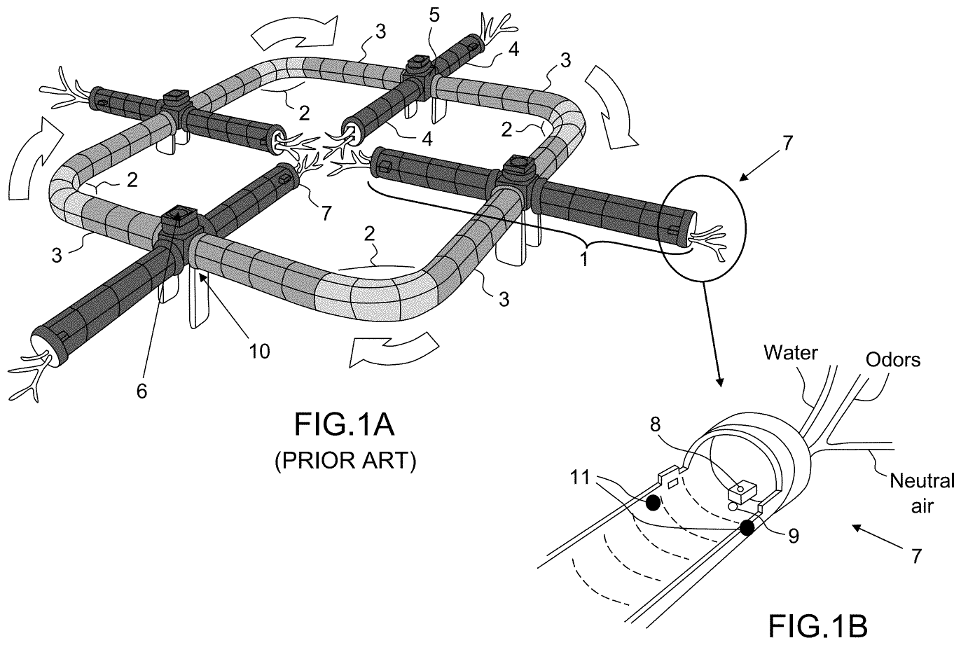

### DETAILED DESCRIPTION OF EMBODIMENTS

Embodiments of the present disclosure will now be described in detail with reference to the accompanying figures. In the following detailed description of embodiments of the present disclosure, numerous specific details are set forth in order to provide a more thorough understanding of the present disclosure. However, it will be apparent to one of ordinary skill in the art that the present disclosure may be practiced without these specific details. In other instances, well-known features have not been described in detail to avoid unnecessarily complicating the description.

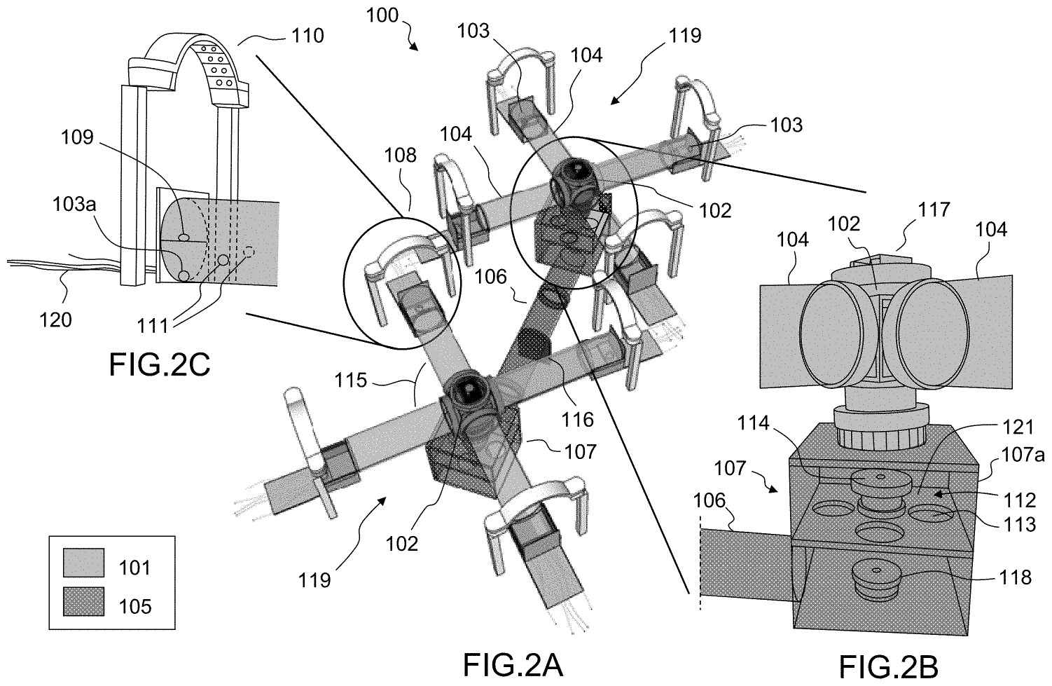

The following description provides one non-limiting example of a system for testing the cognitive ability of a rodent, according to one or more embodiments of the present disclosure. Such system is depicted in FIG. 2A of the present description. The following description also provides one non-limiting example of use of the system illustrated in FIG. 2A.

1. Example of a System for Testing a Rodent's Memory and/or Other Brain Functions

An example of system 100 for testing the memory and/or other brain functions of a rodent 200 is illustrated in FIG. 2A. The system shown in this figure comprises two identical apparatuses 119 for testing the memory and/or other brain functions of a rodent 200 and a transfer chamber 105 connecting the apparatuses 119 to each other.

The system 100 may for example be arranged on a table (not shown) of, for example, 110 cm long and 60 cm wide having two square holes (e.g. 60 cm long and 12.5 cm wide) configured to house the apparatuses 119. The table may be mounted on wheels, and may be of sufficient height (e.g. about 1.5 m) to allow some parts of the apparatus, such as transfer chambers identified below, under the table.

Each apparatus 119 comprises a testing chamber colored in grey and generally designated by reference number 101. Each testing chamber 101 of the system 100 comprises a centrally arranged entrance chamber 102 and a plurality of corridors 104, each connected to the entrance chamber 102 via a first end portion thereof.

In the embodiment shown in FIG. 2A, the corridors 102 radially extend from the centrally arranged entrance chamber 102 and are angularly equally spaced apart from each other. In the system 100 shown in FIG. 2A, the number of corridors 104 connected to each of the two entrance chambers 102 is four and all corridors 104 connected to a given entrance chamber 102 are spaced apart from each other of an angle 115 of 90°. However, a different number of corridors may be envisaged. In this embodiment, the corridors 104 comprise identical straight tubes of circular cross-section having identical dimensions, e.g. 23 cm in length and 5 cm in diameter. The tubes may be made by joining together two half semicircular tubes one on top of the other. The top half tubes can be easily removed in order to clean the system 100, for example in between two tests.

The system 100 further comprises odor diffusers 103, which will be described in more details in the following, for diffusing odors in the corridors 102.

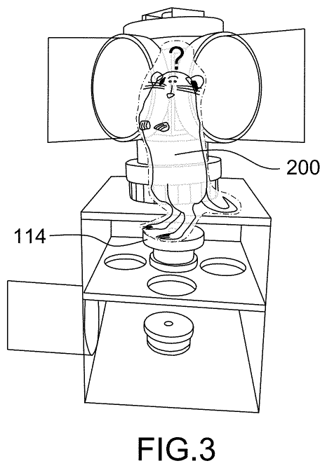

As shown in FIG. 2B, each apparatus 119 further comprises a retarding zone 107 comprising a retarding chamber 107a per each entrance chamber 102. In this example of system 100, each retarding chamber 107a has the form of a cube of side 12 cm. Each retarding chamber 107a is connected to a respective entrance chamber 102 and comprises at least one obstacle 112 configured to slow down the rodent's movement to and from the respective entrance chamber 102. In FIG. 2B, the at least one obstacle 112 comprises a floor 121 fixed at an intermediate height of the retarding chamber 107a and provided with four holes 113. In this example, each hole 113 measures 3.5 cm in diameter. The at least one obstacle 112 further comprises a first platform 114 placed at a predetermined height from the floor 121 of the retarding chamber 107a, adapted to have a rodent's head at the level of the entrance chamber 102, such as illustrated in FIG. 3. In this system 100, the retarding zone 107 further comprises a second platform 118 located below the floor 121 of the retarding chamber 107a for inducing the rodent's movement through the retarding chamber 107.

In order to make the rodent 200 lose its spatial bearings, equiprobability is respected through certain features of the system 100. For example, the corridors 104 are of substantially identical shape and size. Moreover, the two testing chambers 101 are of substantially identical form and size, and the two retarding chambers 107a are also of substantially identical form and size.

The system 100 further comprises a transfer chamber, colored in darker grey in both FIGS. 2A and 2B and generally designated by reference number 105, connected to each entrance chamber 102 via the respective retarding chamber 107 to transfer from a first one of the testing chambers 101 to a second one of the testing chambers 101 and vice versa.

As shown in FIG. 2A, the transfer chamber 105 comprises the retarding chamber 107a of each apparatus 119 and further comprises a transfer tube 106 having end portions each connected to a respective retarding chamber 107a. According to one or more embodiments, the transfer tube 106 comprises an automatic lift door 116 in the middle portion thereof. Such door 116 may be controlled by a control unit (not shown). The door 116 may be set to be closed or open when a rodent is detected in a specific location of the system. For example, the door may be set to be closed when the rodent 200 is detected in a retarding chamber 107a, and/or may be set to be open when the rodent is detected in a second end portion 108 of a corridor 104.

In each apparatus 119 of the system 100, the odor diffusers 103 are arranged in the second end portions 108 of the each corridor 104. As shown in FIG. 2C, each odor diffuser 103 comprises an air port 103a defined in a wall of each corridor 104, in the second end portion 108 thereof. Each odor diffuser 103 further comprises more pipes 120 connected to the air port 103 for carrying as many odors from respective one or more odor sources or reservoirs (not shown). The diffusion of odors or air in the corridors 104 via the air ports 103 is controlled automatically by means of the control unit, according to a predetermined program. Inverted fans 117 are provided on the top of the entrance chambers 102 to direct neutral or scented air diffused from the second end portions 108 of the corridors 104 from the corridors 104 to the entrance chambers 102 of the testing chambers 101. These inverted fans 117 are also controlled by the control unit.

As shown in FIG. 2C, the system 100 further comprises a source of positive reinforcement 109 and a source of negative reinforcement 110, both sources 109 and 110 being provided in the second end portion 108 of all corridors 104. Hence, the system 100 shown in FIG. 2A comprises eight sources of positive reinforcement 109, which may be in the form of small water wells having enough volume to contain 500 μL of water, and eight sources of negative reinforcement 110, which may be in the form of means for emitting a non-aversive light signal, such as LED ribbons distributed on an arc extending above the second end portion 108 of all corridors 104 at a height of 18 cm.

As shown in FIG. 2C, each apparatus 119 further comprises presence sensors 111, including for example photoelectric cells, arranged in each one of the eight second end portions 108 of the eight corridors 104. The photoelectric cells may work in pairs to detect a rodent's movement. For example, one cell may emit an infrared beam that is received by another cell. During a test, an interruption in the infrared beam's reception is caused by the presence of a rodent 200, thus permitting the rodent's detection. In the system 100, the presence sensors 111 are placed 5 cm before each extremity of the corridors 104. The system 100 comprises further photoelectric cells (not shown) at an intermediate height of the retarding chamber 107a for detecting the movement of a rodent in each retarding chamber 107a.

2. Example of Use of the System

To evaluate procedural and declarative-like subcategories of long-term memory, three different strains of mice were submitted in the system 100 described above.

2.1. Description of the Experiment

A first strain of mice was BALB/c Byllco (B) mice because this albinos strain is an excellent learner with olfactory cues (Roman et al.; 2002), but fails to acquire place-learning response in a Morris water maze, which can be explained by an hypersecretion of corticosterone and marked brain catecholamine alterations following stressor exposure.

A second strain of mice was C57BL/6 mice (C), which is one of the most common strains used to make transgenic or gene-targeting mice.

A third strain of mice was DBA/2J mice (D) because of some differences in hippocampal anatomy, with their fewer pyramidal cells in the dorsal hippocampus, fewer mossy fiber terminals in the regio inferior, and poor learning performance with spatial or olfactive cues.

At least 1 week before any training, male adult BALB/c, C57BL/6J and DBA/2J strain mice approximately 8 weeks old were individually housed with free access to food and water in a constant-temperature room (21° C.) maintained on a 12 h light-dark cycle (with lights-on at 07:00 a.m.). Twenty-four mice (eight by strain) were used during three running experiments, corresponding to three mice of the same strain per running experiment.

Prior to testing them in the running experiments, all mice were subjected first to a procedural training aimed at evaluating the procedural-like subcategories of long-term memory, then to a reference training aimed at evaluating the declarative-like subcategories of long-term memory, which are common to the skilled persona and are thus not detailed here.

2.2. Description of the Results

The percentage of correct responses for each mice strain indicates the effectiveness of the association between the odors and their respective rewards, and is related to declarative memory, while the cumulative time that a rodent spends in the system during an experiment indicates its mastery of the task procedure and is related to non-declarative or procedural memory.

Taken as a whole, the results demonstrated that the three mice strains were able to learn the long-term-memory procedure requested to get rewards in the system. However, only the B and C mice consolidated the right associations on long-term reference memory, while the D mice started every session of running experiment from the chance level (i.e., 25%).

The inventors hence showed that the system according to embodiments of the invention provides an experimental frame for sensitive tests that can discriminate mice and effectively and precisely test the different sub-categories of long-term memory.

1. Apparatus for testing the cognitive ability of a rodent, comprising:
a testing chamber comprising:
an entrance chamber,
a plurality of corridors each connected to the entrance chamber via a corridor's first end portion, the plurality of corridors having substantially identical shape and/or dimensions;
at least one odor diffuser arranged in at least one of the plurality of corridors, for diffusing odors in the plurality of corridors; and
at least one source of reinforcement arranged in the at least one of the plurality of corridors;
a retarding zone connected to the entrance chamber and comprising at least one obstacle configured to slow down the rodent's movement to the entrance chamber; and
an optional transfer chamber connected to the entrance chamber via the retarding zone for transfer of the rodent to and from an area external to the apparatus.

2. The apparatus of claim 1, wherein the at least one odor diffuser is arranged in a second end portion of the at least one of the plurality of corridors.

3. The apparatus of claim 1, wherein each corridor of the plurality of corridors comprises an odor diffuser and a source of reinforcement.

4. The apparatus of claim 1, wherein the source of reinforcement comprises a source of positive reinforcement and/or a source of negative reinforcement.

5. Apparatus according to claim 1, wherein the apparatus is a module configured to be connected to one or more further modules identical to the module.

6. Apparatus according to claim 1, wherein the plurality of corridors comprises three or more corridors.

7. Apparatus according to claim 1, wherein the area external to the apparatus includes a rest area and/or further apparatuses.

8. Apparatus according to claim 1, wherein the at least one obstacle comprises a floor provided with at least one hole.

9. Apparatus according to claim 1, wherein the retarding zone comprises a retarding chamber, and the at least one obstacle further comprises a platform arranged at an intermediate height of the retarding chamber, adapted to have the rodent's head at the level of the entrance chamber.

10. Apparatus according to claim 1, comprising at least two testing chambers and/or at least two retarding chambers.

11. Apparatus according to claim 10, wherein the at least two testing chambers are of substantially identical shape and dimensions and/or the at least two retarding chambers are of substantially identical shape and dimensions.

12. Apparatus according to claim 1, further comprising a presence sensor arranged in a second end portion of each of the plurality of corridors.

13. Apparatus according to claim 1, wherein the dimensions of each of the plurality of corridors are between 20 and 26 cm in length and between 3 and 7 cm in diameter.

14. System for testing the cognitive ability of a rodent, comprising a plurality of apparatuses according to claim 1 connected to each other by the transfer chamber.

15. Method for testing the cognitive ability of a rodent, comprising:
introducing a rodent in the apparatus according to claim 1;
diffusing at least one odor in at least one of the plurality of corridors via the at least one odor diffuser;
associating the at least one odor with a reward or a reprimand in at least one of the plurality of corridors;
triggering the release of the reward or the reprimand when the rodent reaches the second end portion of the at least one of the plurality of corridors where the at least one odor is associated with a reward or, respectively, a reprimand; and
assessing a performance of the rodent, wherein the assessing comprises counting the number of times the rodent is successful in getting rewards and/or avoiding reprimands.

16. Method for assessing the efficacy of a drug on a rodent, comprising:
applying the method according to claim 15 to the testing of a first rodent;
applying the method according to claim 15 to the testing of a second rodent;
administering a drug to the second rodent prior to applying the method according to claim 15 to the testing of the second rodent;
comparing the performance of the first rodent with the performance of the second rodent;
assessing the efficacy of the drug based on the comparison between the performance of the first rodent and the performance of the second rodent.

17. Method according to claim 16, wherein the first rodent and the second rodent are from the same strain.
